(19) United States
(12) Patent Application Publication
(10) Pub. No.: US 2010/0094831 A1
(43) Pub. Date: Apr. 15, 2010

(54) NAMED ENTITY RESOLUTION USING MULTIPLE TEXT SOURCES

(75) Inventor: Matthew F. Hurst, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/251,452

(22) Filed: Oct. 14, 2008

(51) Int. Cl. G06F 7/06; G06F 17/30

(52) U.S. Cl. 707/705; 707/E17.014

(57) ABSTRACT

An arrangement for resolving ambiguity among named entities in web based text documents is provided in which multiple documents are utilized that are of different genres and will thus typically use different degrees of precision when referring to named entities. When an ambiguous named entity is located in a document, any links contained in that document are followed to other documents. If a linked document includes a named entity that is fully specified (i.e., includes both a first and last name), then this information can be used to resolve the ambiguity of the named entity in the original document.

### BACKGROUND

Named entities in passages of text are proper nouns such as persons, locations, and organizations. Named entity recognition has been established as an important task in several areas, including for example, topic detection and tracking, machine translation, and information retrieval. A typical goal is the identification of mentions of named entities in text published on the Internet, and their labeling with one of several entity types.

Named entities that are found in text can often be ambiguous. For example, with regard to public figures, the text “Clinton” is ambiguous as to whether it refers, for example, to Hillary Clinton, a current United States Senator representing the State of New York, or Bill Clinton, the former President of the United States. Resolution of such ambiguity is often a key first step that needs to occur before any other inferences about the named entity may be made.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

An arrangement for resolving ambiguity among named entities in text in documents from websites utilizes multiple documents that are of different genres and will thus typically use different degrees of precision when referring to named entities. When an ambiguous named entity is located in a document, any links contained in that document are followed to other documents. If a linked document includes a named entity that is fully specified (i.e., includes both a first and last name), then this information can be used to resolve the ambiguity of the named entity in the original document. So, for example, a weblog post (which is an example of a more informal genre) may ambiguously refer to “Clinton” while including a link to a news article. As the news article is an example of a more formal genre, it can often be expected to use a fully specified named entity, such as “Senator Hillary Clinton,” on its initial reference. The fully specified named entity from the linked news article enables “Clinton” in the weblog to be resolved to the more specific “Hillary Clinton.”

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative computing environment in which the present named entity resolution arrangement may be implemented;

FIG. 2 shows an illustrative set of documents that are collected from various web sites by a named entity resolution service;

FIG. 3 shows a generalized directed graph in which a node is linked to another node by a directed edge;

FIG. 4 shows an illustrative blog (weblog) posting that contains a link to a news article;

FIG. 5 shows an illustrative set of modules that are used to implement the named entity resolution service;

FIG. 6 shows illustrative operative details of the named entity recognition module;

FIG. 7 shows illustrative operative details of the link identification module;

FIG. 8 shows illustrative operative details of the formality ordering module; and

FIG. 9 shows a flowchart of an illustrative algorithm by which multiple documents of different genres may be utilized to resolve named entity ambiguities.

Like reference numerals indicate like elements in the drawings.

### DETAILED DESCRIPTION

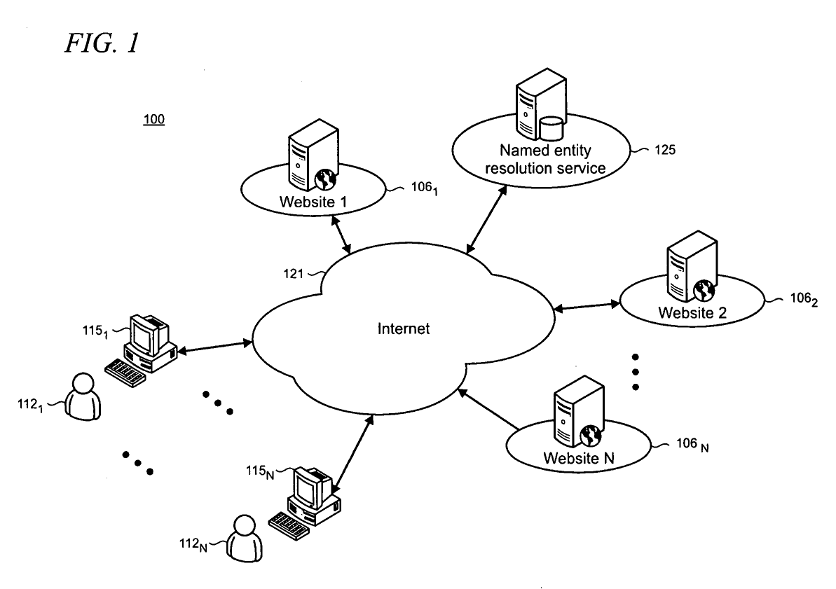

FIG. 1 shows an illustrative computing environment 100 in which the present named entity resolution arrangement may be implemented. A number of websites 106_{1, 2 . . . N} are configured to serve web pages to users 112_{1 . . . N} at PCs (personal computers) 115_{1 . . . N} over a public network such as the Internet 121. The websites 106 can vary in terms of the type of content and the presentation genre that is utilized. For example, some of the websites 106 may host web pages that include documents such as blogs (i.e., weblogs) while other websites could be operated by news organizations and include news articles.

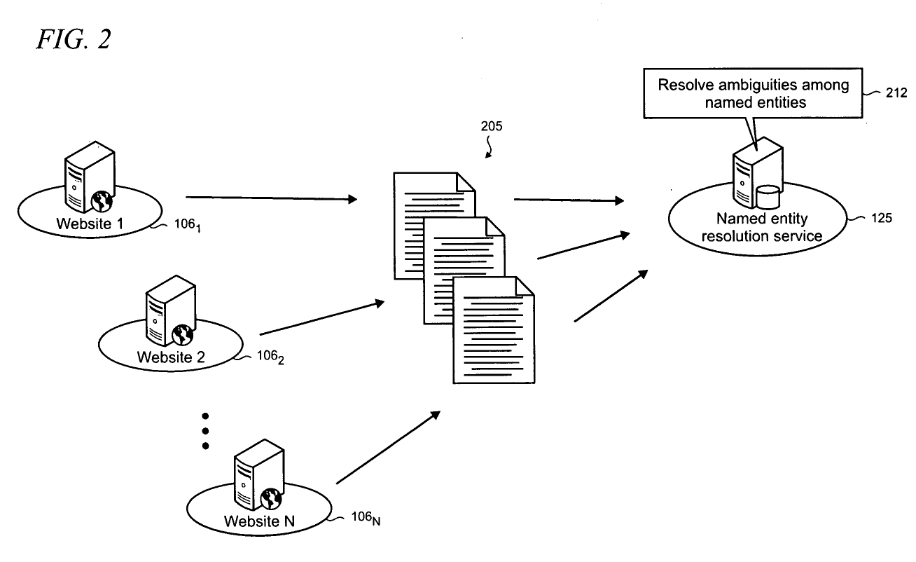

A named entity resolution service 125 is also configured with Internet access. As shown in FIG. 2, the named entity resolution service 125 will collect and process various documents 205 from the different websites 106 in order to resolve ambiguities among named entities in some of the documents (as indicated by reference numeral 212). The named entity resolution service 125 may use the results of the resolution of ambiguities among one or more named entities in a document in a variety of different ways. For example the service 125 may pass the results to a website 106 or other service that needs to accurately identify named entities in documents. Such a website could support a search service where the accuracy of the search results would be improved, or more relevant search results would be returned to a user, when named entity ambiguity is reduced. Other websites may support services which recommend web pages, or provide rankings or other types of webpage filtering. However, it is emphasized that the aforementioned applications are intended to be illustrative and that the named entity resolution service 125 may be configured to meet the needs of various usage scenarios as required.

The present arrangement makes use of the observation that the different types of presentation genres are more or less precise in how they refer to named entities. For example, a news article is more likely, on its initial reference, to use a fully specified version of a name. By contrast, a less formal genre such as a post on a weblog might use a less specific and thus more ambiguous version of that name. In this example, a named entity will be considered fully specified if it includes a first and last name, and underspecified if it does not contain the first and last name.

News articles typically utilize a more formal presentation genre because journalism standards commonly require complete and accurate reporting of identifying information for named entities. This is generally true even when the named entities are well known public figures. In addition, readers of news articles expect a formal presentation genre be utilized along with the accompanying precision in the identification of named entities.

On the other hand, other types of documents may use less formal presentation genres because the readers can receive context from sources other than the document itself In addition, the readers may come to expect a less formal presentation and less precise identification of named entities in some types of documents. For example, with a posting to a weblog about a public figure, the subject matter of the weblog will typically provide some context that the reader can use to identify the named entities in the posting. In addition, postings to weblogs are often written in a casual and informal style and many weblog readers have come to embrace such writing style and will typically accept any limitations that come with it.

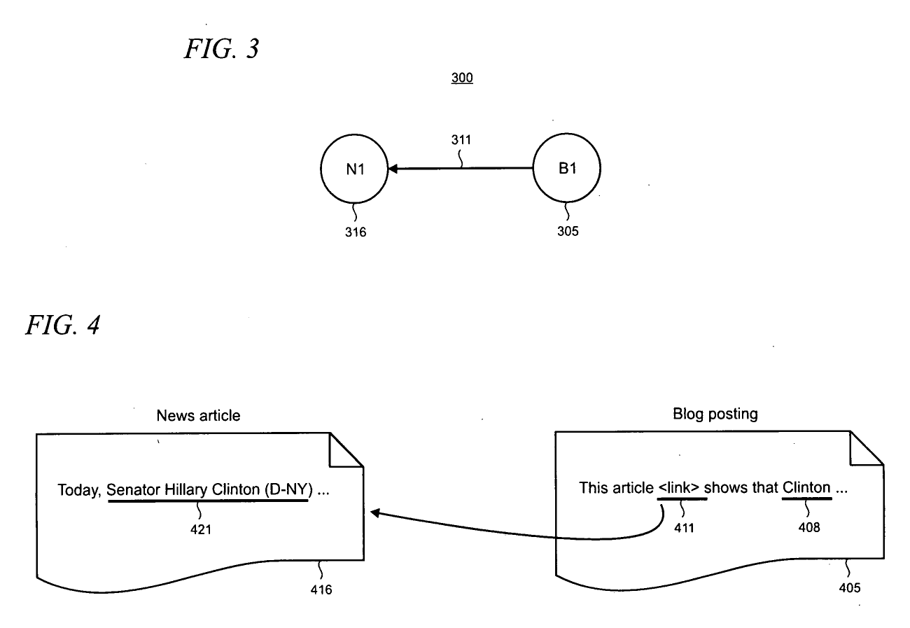

Another observation that is utilized is that it is common for documents to include links (i.e., a hyperlink using hypertext) to other documents. This observation may be represented using an illustrative graph 300, as shown in FIG. 3, in which a node 305 (representing a blog, B1) is connected via an edge 311 (representing a link) to node 316 (representing a news article, N1). The edge 311 is considered a directed edge in this example because B1 refers to N1, but not the other way around. It is also noted that graph 300 is a simple example that shows a single link between the two nodes 305 and 316. In practice, a given node may have links to multiple other nodes, and a node that is linked to may include one or more links to other nodes.

FIG. 4 shows a specific example of linked documents that correspond to the graph 300 (FIG. 3). In this example, a blog posting 405 includes an underspecified named entity (as indicated by reference numeral 408). As the named entity is underspecified (by virtue of not including both the first and last name) the blog posting 405 is ambiguous as to whom it is referring. However, in this example, the blog posting 405 includes a link 411 to a news article 416. As is common in this type of presentation genre, the news article 416 uses a version of the name that is fully specified (as indicated by reference numeral 421).

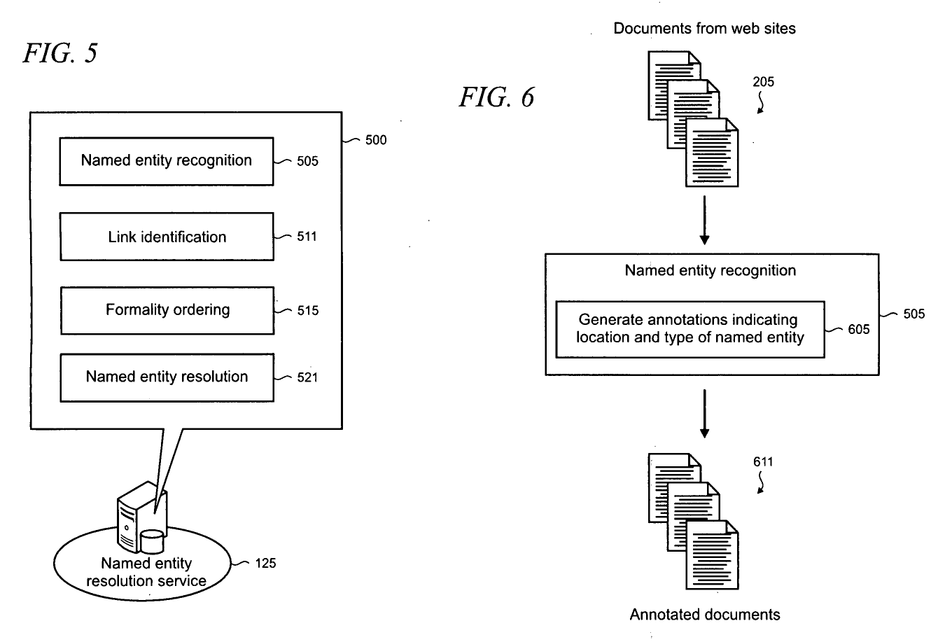

The named entity resolution service 125 employs the above described observations when resolving named entity ambiguities. The named entity resolution service 125, as shown in FIG. 5, is implemented using a variety of different modules 500. In this example, the modules comprise software code that runs on a computing platform, but in other implementations firmware or hardware (or various combinations of software, firmware, and hardware) may also be utilized.

The modules 500 include a named entity recognition module 505; a link identification module 511; a formality ordering module 515; and a named entity resolution module 521. The particular modules shown in this example are intended to be illustrative—it is possible that the particular modules utilized in a given implementation may vary from that shown and/or the functionality provided therein may be allocated among the modules in a different way.

As shown in FIG. 6, the named entity recognition module 505 processes documents 205 from websites 106. The documents 205 can be collected in an automated fashion, using manual methods, or by using a combination of manual and automated techniques. Typically, the documents 205 will be of a known type (e.g., a news article, weblog posts, etc.). In some implementations, the document type identification can be performed in advance of the named entity recognition. In others, the named entity recognition module 505 can identify the type using one or more of a variety of conventional techniques.

The named entity recognition module 505 will parse the documents 205 in order to generate annotations, as indicated by reference numeral 605. Named entity recognition is a well known concept and any of a variety of conventional methodologies may be used depending upon the requirements of the particular implementation. The output of the named entity recognition module 505 will be a set of annotated documents, as indicated by reference numeral 611. The annotations on each document will indicate the location and type of named entities therein.

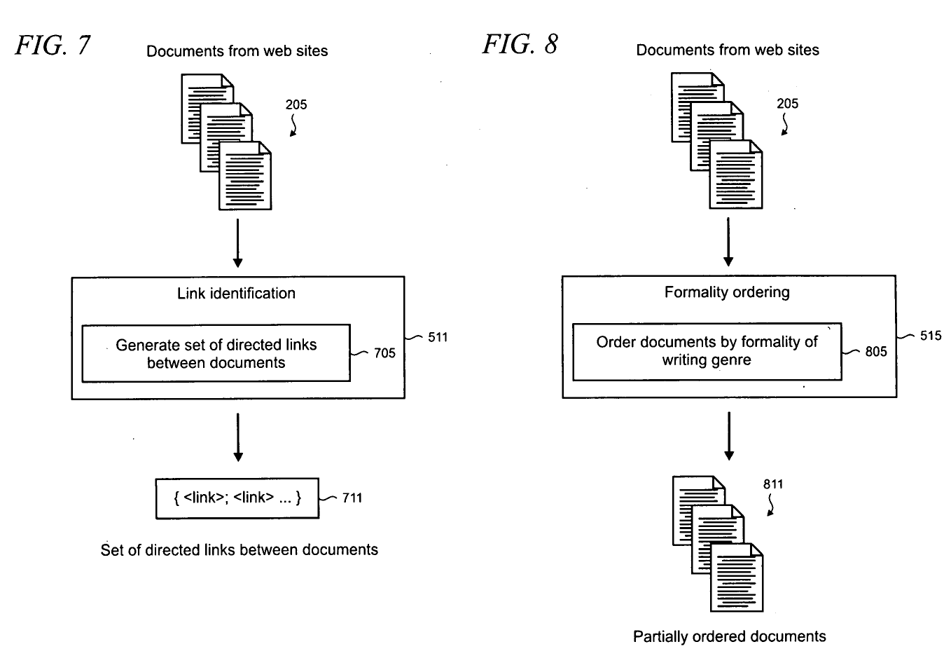

As shown in FIG. 7, the link identification module 511 processes collected documents 205 in order to generate a set of directed links between documents, as indicated by reference numeral 705. Various known techniques may be used in order to identify the directed links contained in a document 205. The output of the link identification module 511 is a set of directed links 711 between the documents 205. In this example, the link identification module 511 is configured to identify the set of directed links 711 by traversing the directed edges between documents in a graph of the documents 205. The traversal is performed along the edges between a document in a node and the documents to which it is linked in adjacent nodes.

As shown in FIG. 8, the formality ordering module 515 orders the collected documents 205 in accordance with the formality of the writing genre, as indicated by reference numeral 805. In this example, the output of the formality ordering module 515 is a partial ordering of the documents 811. The documents are considered partially ordered in that they are ordered in terms of greater or lesser formality of the writing genre. So, for example, a news article can be expected to have greater formality than a weblog post.

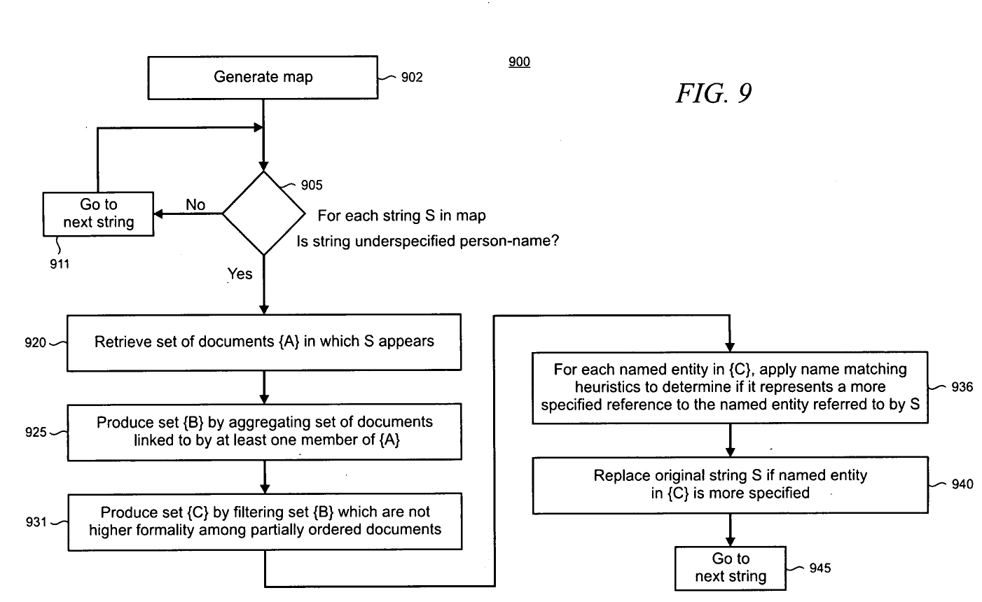

FIG. 9 shows a flowchart of an illustrative algorithm 900 for performing named entity resolution that may be utilized by the named entity resolution module 521. The inputs to the algorithm 900 include a set of documents 205 that are of known types (e.g., news articles, weblog posts, etc.), the set of directed links between documents 711, the annotated documents 611 which indicate the location and type of named entities that are contained therein, and a partial ordering of the documents 811 which indicates the formality of the writing genre utilized in the documents 205.

The algorithm 900 begins by the construction of a map in which named entities are mapped to respective documents (as indicated by reference numeral 902). The map is constructed by examining each document 205 and extracting all the named entities of a certain type. In this example the extracted named entities are person-names (i.e., names of persons). The map comprises a data structure that, given a string (i.e., a named entity), will report the documents 205 that contain the string.

For each string S in the map, a determination will be made if S is an underspecified person-name (905). If S is not an underspecified person-name, then the next string will be checked (911). If S is underspecified, then a set of documents {A} in which S appears will be retrieved (920).

A set of documents {B} is then produced by aggregating the documents that are linked to by at least one member of {A} (925). A set of documents {C} is produced from {B} by filtering those documents which are not of a higher formality among the partially ordered documents (931). Thus, in this example, if S appears in a weblog which includes links to other documents, the linked documents will be filtered out from {C} except for those that are of a more formal writing genre (e.g., news articles).

For each named entity in {C}, one or more name matching heuristics will be applied to determine if the named entity represents a more specified reference to the named entity to which S refers (936). The name matching heuristics typically comprise a rule set for matching S to the named entity in {C} which may include surname matching, honorific stripping, and the like. For example, with surname matching “smith” matches “john smith.” With honorific stripping, “mr smith” matches “john smith.”

If a named entity in {C} is more fully specified than the named entity to which S refers, then S is replaced by that named entity in {C} (940). The next string is then checked (945) using the process shown in steps 905 to 940 and described in the accompanying text. The process is repeated for each string S in the map.

It is noted that while algorithm 900 will generally provide accurate and satisfactory results for many applications, it should be considered only a first order algorithm as it only examines linked documents that are one degree away in the graph. Thus, in some implementations it may be desirable to look deeper in a graph for matches. For example, if a linked document does not contain a fully specified named entity, links in that document may be followed to yet other linked documents which may be processed to identify matches that may be used to resolve named entity ambiguity.

It is also noted that algorithm 900 provides for normalization of the named entities by mapping them to a normalized form. For example:
Hillary→Hillary Clinton
   Alternatively, the named entities may be grounded to some logical representation. For example:
Hillary→_PERSON#123

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-readable medium containing instructions which, when executed by one or more processors disposed in an electronic device, performs a method for resolving an underspecified named entity in a document, the method comprising the steps of:
retrieving a set of documents {A} in which an underspecified string S appears;
aggregating a set of documents {B} that comprise documents to which at least one member of {A} is linked;
filtering {B} to produce a set of documents {C}, the filtering comprising filtering out members of {B} having formality that is equal or less than a formality of {A}; and
applying one or more heuristics to each named entity in {C} to determine if a named entity is a fully specified reference to the named entity referred to by S.

2. The computer-readable medium of claim 1 in which the method includes a further step of replacing S with the named entity from {C} if it is a fully specified reference.

3. The computer-readable medium of claim 1 in which an underspecified string does not include both a first name and a last name, and a fully specified named reference includes both a first name and a last name.

4. The computer-readable medium of claim 1 in which the one or more heuristics comprise name matching heuristics.

5. The computer-readable medium of claim 1 in which the method includes a further step of generating a map comprising a data structure in which a named entity will report a list of associated documents which contain the named entity.

6. The computer-readable medium of claim 5 in which the generating comprises extracting all named entities of a certain named entity type from a set of documents.

7. The computer-readable medium of claim 6 in which the named entity type comprises person-names.

8. The computer-readable medium of claim 6 in which the set of documents comprise documents collected from websites.

9. An automated method for operating a named entity recognition system, the method comprising the steps of:
collecting a set of documents of known type, the set of documents comprising text documents having different presentation genres;
collecting a set of directed links between the documents;
performing named entity recognition on the set of documents to generate annotations on each document which indicate locations and types of named entities contained therein;
following a link from a first document to a second document having a presentation genre which has a higher degree of formality compared with the presentation genre of the first document; and
using a named entity in the second document to resolve a named entity in the first document.

10. The automated method of claim 9 in which the named entity in the first document is underspecified and the named entity in the second document is fully specified.

11. The automated method of claim 9 in which the named entity is one of person-name, location-name, or organization-name.

12. The automated method of claim 9 including a further step of applying one or more heuristics to match the named entity in the first document to the named entity in the second document.

13. The automated method of claim 12 in which the one or more heuristics comprise one of surname matching or honorific stripping.

14. The automated method of claim 9 including a further step of providing results from the named entity recognition system to a provider of a website.

15. The automated method of claim 14 in which the website provides one of search, information retrieval, topic detection and tracking, machine translation, recommendation, or ranking.

16. A computer-readable medium containing instructions which, when executed by one or more processors disposed in an electronic device, perform a method for resolving a named entity using multiple text sources, the method comprising the steps of:
extracting named entities in a first text source using a named entity recognition system;
following links in the first text source to one or more other text sources, the one or more other text sources being of a more formalized presentation genre compared to the first text sources;
extracting named entities from the one or more other text sources; and
resolving the extracted named entities in the first text source using the extracted named entities from the one or more other text sources.

17. The computer-readable medium of claim 16 in which the resolving comprises normalization of a named entity to a normalized form or grounding a named entity to a logical representation.

18. The computer-readable medium of claim 16 in which the links comprise hyperlinks.

19. The computer-readable medium of claim 16 in which the multiple text sources are hosted by respective web servers that are accessible over the Internet.

20. The computer-readable medium of claim 16 in which the named entity recognition system applies one or more heuristics to match the named entity in the first text source to named entities in the one or more other text sources.
